(19) United States
(12) Patent Application Publication
(10) Pub. No.: US 2002/0036949 A1
(43) Pub. Date: Mar. 28, 2002

(54) NEW PROCESS FOR RAPID AND HOMOGENEOUS MIXING OF FLUIDS IN CONTINUOS OPERATIONS

(76) Inventors: HEINRICH E FIEDLER, BERLIN (DE); GUIREN WANG, MISSISSAUGA (CA)

Correspondence Address: EUGENE J A GIERZAK, KEYSER MASON BALL, 201 CITY CENTRE DRIVE, SUITE 701, MISSISSAUGA, ONTARIO, L5B 2T4, CA

(21) Appl. No.: 09/283,198

(22) Filed: Apr. 1, 1999

(30) Foreign Application Priority Data
Apr. 3, 1998 (DE) 19816354.1

(51) Int. Cl. B01F 3/00

(52) U.S. Cl. 366/118; 366/348

(57) ABSTRACT

An apparatus and process for the mixing of two or more fluid streams and creating streamwise vortices. The apparatus comprises of a chamber having a proximal end, a distal end, a corresponding frequency means for forcing the mixing of the two or more fluid streams, an inlet means for receiving the two or more fluid streams at the proximal end and a divider means for separating the two or more fluid streams mounted within the chamber at the proximal end.

### FIELD OF INVENTION

The present invention relates to combustion, chemical industry, food industry, pharmaceutical industry, biotechnology, polymer processing, environmental engineering, aircraft, Heat Ventilation Air Condition, power plant and so on.

### DESCRIPTION OF THE PRIOR ARTS

Traditional mixing processes are either based on the mechanism of fluid mechanics (producing shear layer, e.g., mixing layer, jet and wake) or mechanical process (agitated tanks). There are some methods for flow control used to control the mixing. These are either passive control (static mixers) and active control (initial disturbance of mixing layer, jet and wake though actuators). These passive controls use insert of some vortex generator or other devise to change the fluid flow for mixing enhancement (motionless mixers). These active controls aim at the initial control of the Kelvin-Helmholtz vortex (jet and mixing layer) and von Karman vortex (wake) based on traditional receptivity theory. Therefore agitated tanks does not belong to the active control. For the control based on traditional receptivity, there is only one Strouhal number, and under which, the excitation achieves maximum receptivity, i.e., maximum mixing enhancement. If the excitation level is very strong, its sub- and super-harmonic frequencies can also achieve maximum mixing enhancement. The Strouhal number corresponding to the maximum receptivity scales with convection velocity of the fluids.

### THE NEW MIXING PROCESS OF A MIXER PROPOSED HERE

Based on a new receptivity mechanism discovered by the authors, i.e., the characteristic instability of the flows, the new mixing process of the mixer uses both, new passive and active control of fluid flow to achieve an extraordinary rapid and homogeneous mixing of fluids by smallest external energy input.

The construction and mixing process is as follows. The new mixer is under continues operations. It consists of one or more tubes. In each tube, there is a splitter plate in the inlet, which separates the two streams of fluids, which are to be mixed. The two fluids come to the mixing tube through the different side of the splitter plate and meet each other directly downstream of the trailing edge of splitter plate. The initial two flows of fluids can parallel or by an angel meet each other at the trailing edge. The average velocity of the two streams can be the same (wake) or different (mixing layer).

The two streams and the flow downstream of the splitter plate in the mixing chamber can be natural or excited flows. The impetus influence (excitation) can be active (through external input of energy) or passive (through the flow self-induced energy). Through the suitable excitation, an extraordinary rapid mixing of the two streams can be achieved directly downstream of the splitter plate. This effect will be stronger if the temperature or density of the two streams is different.

The principle of the method can be shown as follows. Traditionally it is assumed that the high turbulent intensity can achieve intensive mixing. The high turbulent intensity will be produced through mechanical agitation, which need a great amount of energy (agitated tank), or through jet, whose mixing rate is not high enough for many situations.

The proposed new rapid mixing process is based on a new receptivity mechanism discovered by the authors recently. The flows, on which the proposed process for mixing is based, are plane shear flows (shear layer or wake), which, through the geometry of confinement of the coming streams and the mixing chamber, are three dimensional with the overlap of the streamwise vortices. The strengthened mixing process is initiated first through the shear flow, which is the result of the flow instability (instability of induction) downstream of the trailing edge. Through this instability mechanism, the external input periodical disturbance will in the flow be amplified maximum under some specific frequency (which does not scale with convection velocity), and meanwhile, downstream of the trailing edge, the vortices (primary structures) normal to the streamwise direction are induced at the same period. The three dimensionality of the fundamental flow breaks down the primary structures very rapidly, and producing very small structures and thus results in the rapid mixing of the two streams finally. The optimal amplification of the initial disturbance and its corresponding rapid mixing process depends strongly on the excitation frequency, i.e. only for a specific excitation frequency, can the mixing be strongly enhanced. This is important for the fast mixing in small Reynolds number flows, where the mixing is slow by other mixing process.

An example of the mixing is displayed here.

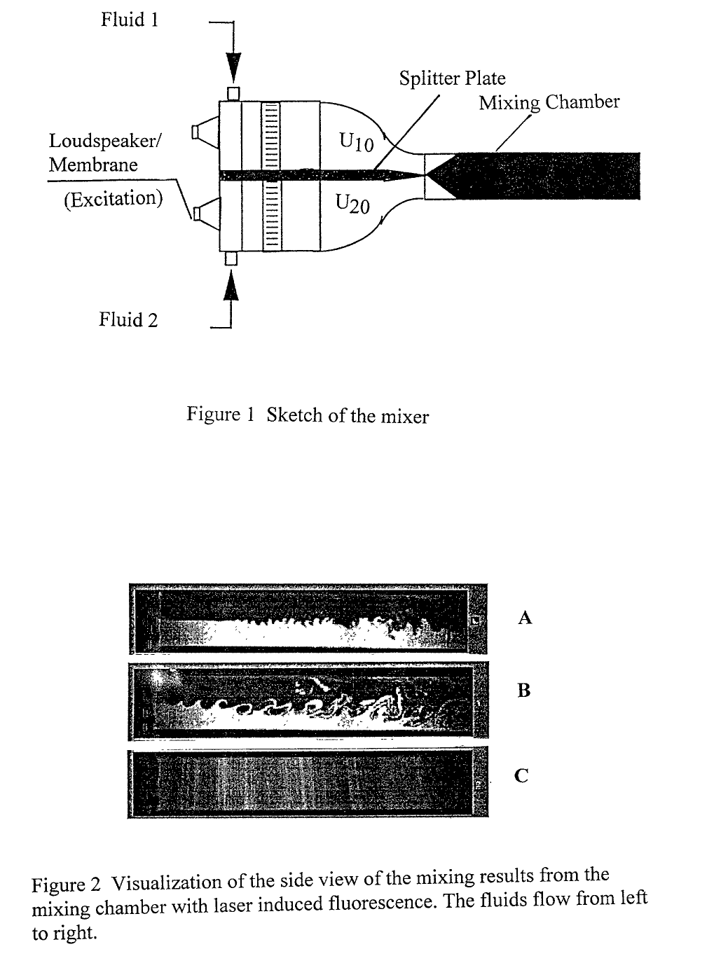

FIG. 1 shows a greatly simplified sketch of the investigated apparatus, in which the phenomenon of the mixing process is studied. The periodic disturbance can be realized through a vibrating trailing edge or through periodic fluctuation of one stream, e.g. over a piston-/membrane mechanism (in this experiment through a membrane excited by a loudspeaker) or a temporal variable flow resistant in one of the two streams. The two streams, one of which are with dye, meet each other downstream of the trailing edge at the beginning of the whole tube length, i.e., the mixing chamber. The flow can be visualized through laser induced fluorescence.

FIG. 2 shows the visualized mixing results from the side view for three different situations. Each picture now shows the following situations:

FIG. 2a: The initial average velocities of the two streams are the same (wake with velocity of 40 cm/s). The mixing is very poor and similar to that in the classic tube flow.

FIG. 2b: Flow with changed inlet condition; here, different initial average velocity of the two streams (5/10 cm/s). The mixing is clearly a little better than FIG. 2a, according to the large structures.

FIG. 2c: Here the flow is periodically excited through the new mixing process. The mixing is now, compared with the other two situations, on the whole, completely another quality. The finest structures homogeneity of the two streams over the whole across-section of the tube are already achieved clearly and no clear large structures are visible just downstream of the trailing edge.

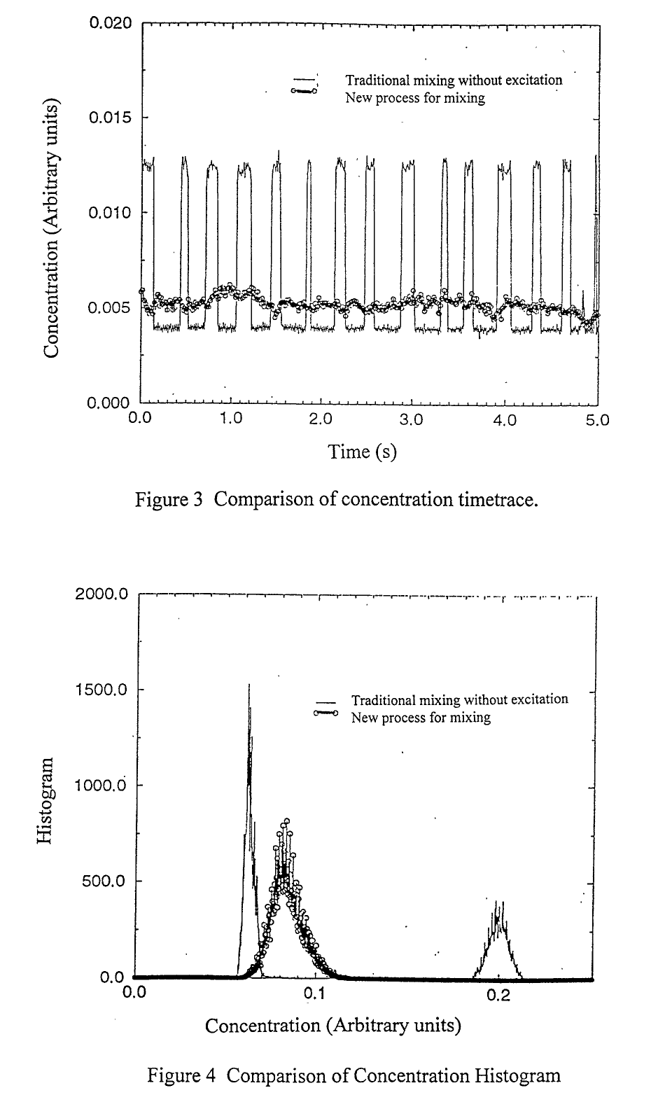

FIG. 3 shows the concentration timetrace of the mixing without excitation and with excitation by the new process.

FIG. 4 presents the concentration-Histogram: by the traditional mixing process, there are two peaks corresponding to the initial concentrations of the two streams respectively, indicating that the fluids are not mixed. By the new mixing process, however, there is only one peak corresponding to the mixed concentration of the two streams, showing that the two streams are mixed.

### 4 COMPARISON WITH OTHER MIXING PROCESSES

### 4.1 Disadvantages of the Other Mixers

With mechanical excitation, the agitated mixers use to much energy in order to achieve better mixing and there is often died region for mixing so that the quality of chemical products becomes low, and so does mixing efficiency. The process costs more money due to inefficiency. Cells can be destroyed by too strong shear stress near blade surface in biotechnology. With chemical reaction, the product quality can be affected due to the approximately exponent residence time distribution.

Mixing through jet, mixing layer, wake, motionless and static mixer can be too slow.

All these flows have a large range of different structures (scales), which make the modeling of the mixing much complicated. Especially when there is chemical reaction.

Direct losses in USA chemical processing industries alone, due to the problems of mixing, are estimated at $10 Bn a year.

### 4.2 Advantages of the New Mixing Process

In this new mixing process, the modern knowledge of flow control is effectively used, both passive and active control. It has many advantages:

Due to the maximum receptivity, the input energy is optimally transferred to small scales from large scales so that the achieved mixing enhancement and efficiency is clearly much higher than others used:

The mixing chamber is fully used.

No died and back flow region exists.

Since no blade is used, the problem with cell breaking can be solved.

The installation of the mixer and its construction is simpler.

The process is in continues operations.

It is easier to control the mixing and temperature.

When used for reactor, the scaleup would be easier, due to the fact that the scale of scalar is more homogeneous distributed because of the possibility of the control of the small structures and therefore the reactor modeling can be more accurate.

What is claimed is the process of mixing of fluids, which is based on the receptivity mechanism, i.e., the periodical excitation of the characteristic instability behavior of the shear layer (mixing layer or wake) downstream of the splitter plate between the two initial streams for a given special geometry of the mixing chamber. For a given special geometry of the mixing chamber and the three dimensionality of the flow there exists a selective receptivity of the unstable shear layer between the two streams by a frequency, which depends on the geometry and size of the mixing chamber. The excitation under this suitable frequency leads to a continues, very homogeneous mixing over a short downstream distance from the trailing edge.

The process is characterized by

1) A whole mixing chamber, consisted of one or more tubes, in each of which the fluids, which are to be mixed, come in separately and will first meet each other there downstream of the trailing edge of the splitter plate. The flow becomes three dimensional due to the secondary vortices, two kinds of which are produced in the corner between the splitter plate and the tube wall and other two of which are produced in the center line of the tube parallel to the streamwise direction. As a result, the three dimensional structure are constructed due to the influence of the wall, and the three dimensionality, in turn, is essential for the function of the mixing process.

2) The necessary excitation for the mixing process, which is based on a new receptivity mechanism discovered by the authors recently and also characterized by the three dimensional structures. This requires the fluid velocity of one of the two initial streams or both streams to be overlapped by a periodic component, i.e. U(t)=U₀+u(t), and u(t)=u(t+T), where U and U₀ is the transient and average local velocity respectively, t and T is time and time period respectively. Not only the frequency, but also the periodic fluctuation amplitude of the excitation should be adjustable to match the geometry of a given mixing chamber for the optimization of the mixing process. Several methods can be used to produce the periodic velocity component, such as a forced flap in trailing edge, forced membrane, piston-pump or a periodic adjustable valve upstream of the trailing edge.
